(19) United States
(12) Patent Application Publication
(10) Pub. No.: US 2007/0085828 A1
(43) Pub. Date: Apr. 19, 2007

(54) Ultrasonic virtual mouse

(76) Inventors: Dale W. Schroeder, Scotts Valley, CA (US); Ken A. Nishimura, Fremont, CA (US); John Stewart Wenstrand, Menlo Park, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/250,069

(22) Filed: Oct. 13, 2005

(51) Int. Cl. G09G 5/08

(52) U.S. Cl. 345/158

(57) ABSTRACT

An ultrasonic device determines a position of a user-controlled object within a virtual mouse region. The ultrasonic device includes an ultrasonic transmitter, spatially separated ultrasonic receivers and a processor. The ultrasonic transmitter produces an ultrasonic pulse and radiates the ultrasonic pulse into the virtual mouse region. The ultrasonic receivers receive a reflected ultrasonic pulse reflected from the user-controlled object within the virtual mouse region and produce respective reflected ultrasonic signals in response thereto. The processor determines the position of the user-controlled object within the virtual mouse region based on the reflected ultrasonic signals, and generates a position signal indicative of the position.

### BACKGROUND OF THE INVENTION

Traditional cursor control devices for controlling movement of a cursor to point to and/or select items or functions on a display of a desktop or laptop computer include arrow keys, function keys, mice, track balls, joysticks, j-keys, touchpads and other similar devices. Of these, the most popular cursor control device is the mouse. Essentially, a mouse operates using a mechanical, optomechanical or optical mechanism to translate motion of the mouse across a workspace into electrical signals that produce motion of the cursor on the display. The mouse is typically located on a mouse pad or other surface adjacent a keyboard, and operation of the mouse requires the user to move his or her hand from the keyboard to the mouse.

Although the mouse is an adequate cursor control device for many applications, in environments in which the mouse must operate in a limited workspace, users are generally dissatisfied with the maneuverability, and therefore, effectiveness of the mouse. In addition, in some situations, it may be undesirable and/or inefficient for a user to remove his or her hand from the keyboard in order to control the mouse. For example, if the user is a stockbroker, an employee responsible for handling customer service matters or other user that is required to both access and enter information quickly, any delays caused by the user moving his or her hand between the keyboard and the mouse may result in lost profits, customer dissatisfaction and other adverse effects.

Another common cursor control device found on laptop computers is the j-key. The j-key is a thin joystick cursor control device incorporated between keys of a keyboard. Due to the small size of the j-key, the j-key easily fits into the form factor of laptop computers, thereby eliminating the need for an externally connected mouse. However, many users find that the j-key difficult to use and has poor resolution. Therefore, in lieu of or in addition to the j-key, some laptop computers also employ a touchpad. Touchpads are binary devices that output binary signals indicative of whether the pressure applied at a given point on the touchpad is greater than or less than a threshold. From the binary signals, a profile of the user's finger pressed against the touchpad is produced, and a centroid of the profile is computed. The relative position between the centroid of the current profile and the centroid of a previous profile on the touchpad is mapped to a change in position of the cursor on the display.

However, the static coefficient of friction on most touchpad surfaces makes it difficult for the user to control cursor movements. In general, for the user to move the user's finger relative to the touchpad surface, the user must apply sufficient force to overcome the static coefficient of friction of the surface. In many cases, the high static coefficient of friction on touchpad surfaces causes the user to apply excessive force and, therefore, “overshoot” the desired position on the touchpad surface. As a result, movements of the user's finger relative to the touchpad surface produce unpredictable results in the centroid computation, which can create undesired cursor motion on the display.

There is therefore a need for a high resolution cursor control device that is easily controllable, accessible and useable in small workspaces.

### SUMMARY OF THE INVENTION

Embodiments of the present invention provide an ultrasonic device for determining a position of a user-controlled object within a virtual mouse region. The ultrasonic device includes an ultrasonic transmitter, spatially separated ultrasonic receivers and a processor. The ultrasonic transmitter produces an ultrasonic pulse and radiates the ultrasonic pulse into the virtual mouse region. The ultrasonic receivers receive a reflected ultrasonic pulse reflected from the user-controlled object within the virtual mouse region and produce respective reflected ultrasonic signals in response thereto. The processor determines the position of the user-controlled object within the virtual mouse region based on the reflected ultrasonic signals, and generates a position signal indicative of the position.

In one embodiment, the processor is operable to compare the position to a previous position to determine a relative change in position of the user-controlled object to generate the position signal. In an exemplary embodiment, the position signal is used to produce incremental movement of a cursor on a display from an original position on the display to a new position on the display. In another embodiment, the position signal is used to map the position of the user-controlled object in the virtual mouse region to a position of the cursor on the display.

In a further embodiment, the processor is operable to detect a click event based on the reflected ultrasonic signals. For example, in one embodiment, the processor is operable to detect a click event when a difference between a time at which the reflected ultrasonic signals are first received and a time at which the reflected ultrasonic signals are no longer received is less than a threshold.

Embodiments of the present invention further provide a method for determining a position of a user-controlled object within a virtual mouse region. The method includes radiating an ultrasonic pulse into the virtual mouse region and receiving at diverse locations a reflected ultrasonic pulse reflected from the user-controlled object within the virtual mouse region. The method further includes determining the position of the user-controlled object within the virtual mouse region based on the receipt of the reflected ultrasonic pulse at the diverse locations.

### BRIEF DESCRIPTION OF THE DRAWINGS

The disclosed invention will be described with reference to the accompanying drawings, which show important sample embodiments of the invention and which are incorporated in the specification hereof by reference, wherein:

FIG. 1 is a perspective view of an exemplary electronic device with an ultrasonic virtual mouse, in accordance with embodiments of the present invention;

FIG. 2 is a side view of the ultrasonic virtual mouse, in accordance with embodiments of the present invention;

FIG. 3A is a schematic diagram illustrating the transmission and reception of ultrasonic pulses, in accordance with embodiments of the present invention;

FIG. 3B is a timing diagram illustrating the time differences between a transmitted ultrasonic pulse and received ultrasonic pulses;

FIG. 3C is a schematic diagram illustrating the intersection of semi-ellipses determined from the time differences of FIG. 3B;

FIG. 4 is a block diagram illustrating an exemplary ultrasonic device for generating a position signal to control movement of a cursor on a display of an electronic device, in accordance with embodiments of the present invention; and

FIG. 5 is a flow chart illustrating an exemplary process for determining position using an ultrasonic virtual mouse, in accordance with embodiments of the present invention.

### DETAILED DESCRIPTION OF THE EXEMPLARY EMBODIMENTS

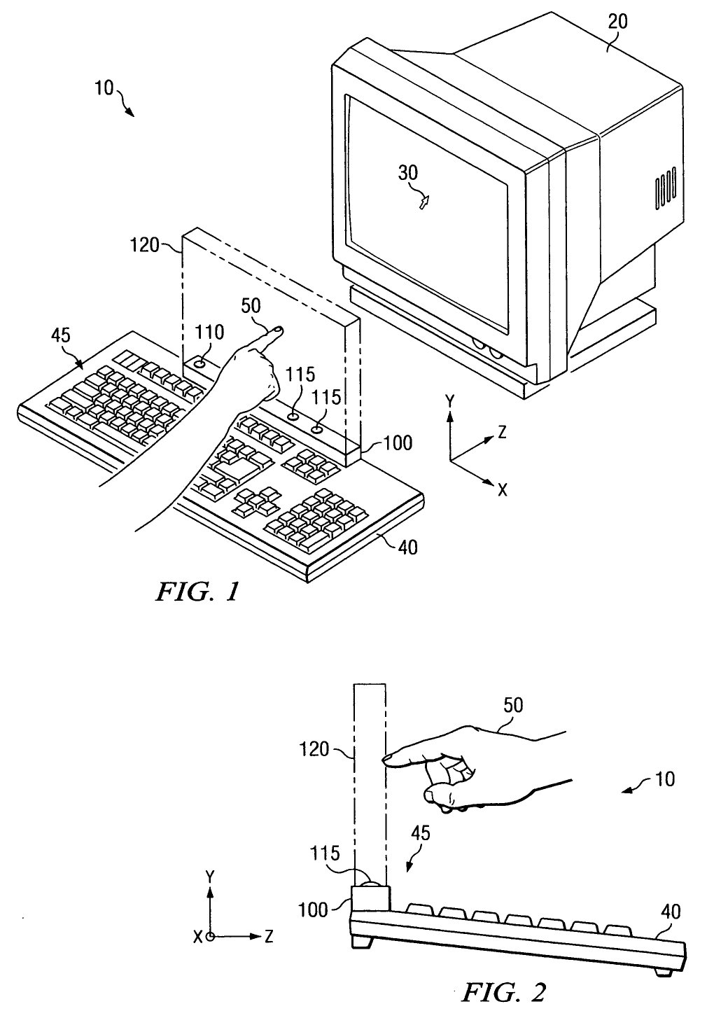

FIG. 1 is a perspective view of an exemplary electronic device 10 including an ultrasonic virtual mouse 100 for determining the position of a user-controlled object 50, such as a finger, pen, pointer or other stylus, within a virtual mouse region 120, in accordance with embodiments of the present invention. The electronic device 10 shown in FIG. 1 is a desktop computer. However, in other embodiments, the ultrasonic virtual mouse 100 is implemented in another electronic device. For example, various electronic devices include wireless (cellular) telephones, personal digital assistants (PDAs), laptop computers, notebooks, hand-held video game devices, portable music players or other similar electronic devices.

The ultrasonic virtual mouse 100 is shown located on the top surface 45 of a keyboard 40 of the electronic device 10. However, it other embodiments, the ultrasonic virtual mouse 100 is located on a side surface of the keyboard 40 or is a stand-alone device. In embodiments in which the ultrasonic virtual mouse 100 is located on the keyboard 40, the ultrasonic virtual mouse 100 is mounted on or otherwise affixed to the keyboard 40 using any attachment mechanism. For example, the ultrasonic virtual mouse 100 can be adhered to the top surface 45 of the keyboard 40 using an adhesive strip or glue. As another example, the ultrasonic virtual mouse 100 can be positioned on a side surface of the keyboard 40 using a clamp. The ultrasonic virtual mouse 100 can be built into the keyboard 40 or can be a separate device attachable to the keyboard 40 by the user.

The ultrasonic virtual mouse 100 includes an ultrasonic transmitter 110 and spatially separated ultrasonic receivers 115. The example shown has a single ultrasonic transmitter 110 and two ultrasonic receivers 115, but the ultrasonic virtual mouse 100 may have more than one ultrasonic transmitter 110 and more than two ultrasonic receivers 115. In one embodiment, the ultrasonic virtual mouse 100 includes two or more ultrasonic transmitters 110, each for producing and transmitting a respective ultrasonic pulse at a different time. For example, the transmitters 110 can be configured such that the ultrasonic transmitters 110 sequentially transmit respective ultrasonic pulses. In other embodiments, one or more of the ultrasonic transmitter 110 and/or ultrasonic receivers 115 are transceivers, each including both an ultrasonic transmitter 110 and an ultrasonic receiver 115. The number of transmitters 110 and receivers 115 is configurable depending on the desired resolution of the ultrasonic virtual mouse 100.

Each ultrasonic transmitter 110 is capable of producing a respective ultrasonic pulse and radiating the ultrasonic pulse into the virtual mouse region 120 located above the ultrasonic transmitter 110 and ultrasonic receivers 115 (i.e., in a direction orthogonal to the plane of the transmitters 110 and receivers 115). The ultrasonic pulse transmitted by the ultrasonic transmitter 110 is reflected off the user-controlled object 50 positioned within the virtual mouse region 120. Each ultrasonic receiver 115 is capable of receiving the reflected ultrasonic pulse reflected from the user-controlled object 50. As used herein, the term “virtual mouse region” 120 refers a region within which an ultrasonic pulse transmitted by an ultrasonic transmitter 110 can be reflected off a user-controlled object 50, and detected by an ultrasonic receiver 115.

Entry of a user-controlled object 50 into the virtual mouse region 120 is detected when an ultrasonic pulse reflected off the user-controlled object 50 is received by at least two of the ultrasonic receivers 115. Each ultrasonic receiver 115 receives the reflected ultrasonic pulse at a time dependent upon the distance between the ultrasonic receiver 115 and the user-controlled object 50. Therefore, with knowledge of the time at which an ultrasonic pulse is transmitted by an ultrasonic transmitter 110 and the time at which each of the two or more ultrasonic receivers 115 receives the reflected ultrasonic pulse, the position (e.g., x, y coordinates) of the user-controlled object 50 in the virtual mouse region 120 is determined. More generally, the position (e.g., x, y coordinates) of the user-controlled object 50 in the virtual mouse region 120 is determined from the differences between the time that the ultrasonic pulse is transmitted by the ultrasonic transmitter 110 and the times at which the reflected ultrasonic pulse is received by the ultrasonic receivers 115.

In FIG. 1, the ultrasonic receivers 115 are shown positioned adjacent one another along the length of the keyboard 40 in the x-direction. In another embodiment, the ultrasonic receivers 115 are arrayed in two dimensions (e.g., x-direction and z-direction) along the length of the keyboard 40 for use in detecting the position of the user-controlled object 50 in the virtual mouse region 120 in the z-direction.

The width (in the x-direction), the height (in the y-direction) and the depth (in the z-direction) of the virtual mouse region 120 are configurable based on the application and/or usage of the ultrasonic virtual mouse 100. In one embodiment, the dimensions of the virtual mouse region 120 are set in software at the time of manufacture. In another embodiment, the dimensions of the virtual mouse region 120 are configurable by the user. For example, the user can set the dimensions of the virtual mouse region 120 by positioning the user-controlled object 50 at desired corners of the virtual mouse region.

As an example, if the user desires the virtual mouse region 120 to occupy the entire area of the display 20, the user can position the user-controlled object 50 at the comers of the display 20 to set the virtual mouse region 120 to the display area 20. In such a configuration, there is a one-to-one correspondence between position of the user-controlled object 50 within the virtual mouse region 120 and the position of the cursor 30 on the display 20. Therefore, in one exemplary embodiment, the position of the user-controlled object 50 within the virtual mouse region 120 maps directly to the position of the cursor 30 on the display 20. In another exemplary embodiment, movement of the user-controlled object 50 within the virtual mouse region 120 is translated into movement of a cursor 30 on a display 20.

In an exemplary operation, when the user places the user-controlled object 50 within the virtual mouse region 120, an ultrasonic pulse transmitted by the ultrasonic transmitter 110 is reflected off the user-controlled object 50 and received at the two or more ultrasonic receivers 115. Based on the differences between the times at which each of the ultrasonic receivers 115 receive the reflected ultrasonic pulse and the time at which the ultrasonic pulse is transmitted by the ultrasonic transmitter 110, the ultrasonic virtual mouse 100 determines an absolute current position (x, y coordinates) of the user-controlled object 50 within the virtual mouse region 120.

From the absolute current position of the user-controlled object 50 within the virtual mouse region 120, the ultrasonic virtual mouse 100 generates a position signal to control the position of the cursor 30 on the display 20. In embodiments in which the position of the user-controlled object 50 within the virtual mouse area 120 maps directly to the cursor position, the position signal is indicative of the current position of the cursor 30 on the display 20 and is used to control the position of the cursor 30 on the display 20. In embodiments in which movement of the user-controlled object 50 within the virtual mouse area 120 translates into movement of the cursor 30 on the display 20, the position signal is indicative of a relative change in position of the user-controlled object 50 in the virtual mouse region 120 from a previous position of the user-controlled object 50 in the virtual mouse region 120 and is used to produce incremental movement of the cursor 30 on the display 20 corresponding to the relative change in position.

The ultrasonic virtual mouse 100 is also capable of detecting a click event performed by the user-controlled object 50. As used herein, the term “click event” refers to a selection, execution or drag function as performed by a left button of a conventional mouse. By way of example, but not limitation, click events include a single click function, a double click function and a click and drag function. In one embodiment, the ultrasonic virtual mouse 100 detects a click event when the user-controlled object 50 enters and exits the virtual mouse region 120 within a predetermined time interval. Thus, the ultrasonic virtual mouse 100 detects a click event when the difference between the time at which the ultrasonic receivers first receive reflected ultrasonic pulses reflected from the user-controlled object 50 and the time at which the ultrasonic receivers no longer receive reflected ultrasonic pulses from the user-controlled object 50 is less than a predefined time interval.

As an example, after the user has positioned the cursor 30 at the desired location on the display 20 by moving a finger within the virtual mouse region 120 and removing the finger from the virtual mouse region 120, the ultrasonic virtual mouse 100 detects a click event when the user's finger subsequently enters and exits the virtual mouse region 120 within a time less than the predefined time interval. As another example, the user can indicate a click event by maintaining a first finger within the virtual mouse region 120, and then entering a second finger into the virtual mouse region 120 and removing the second finger from the virtual mouse region 120 within a time less than the predetermined time interval.

FIG. 2 is a side view of an exemplary ultrasonic virtual mouse 100, in accordance with embodiments of the present invention. As can be seen in FIG. 2, the ultrasonic virtual mouse 100 is mounted on the top surface 45 of the keyboard 40, and the virtual mouse region 120 is located above the ultrasonic virtual mouse 100 (in the y-direction). As the user moves the user-controlled object 50 within the virtual mouse region 120 in the x-direction and/or y-direction, the ultrasonic receivers 115 detect the motion of the user-controlled object 50 by measuring the difference in the times at which the reflected ultrasonic pulse reflected off the user-controlled object 50 is received.

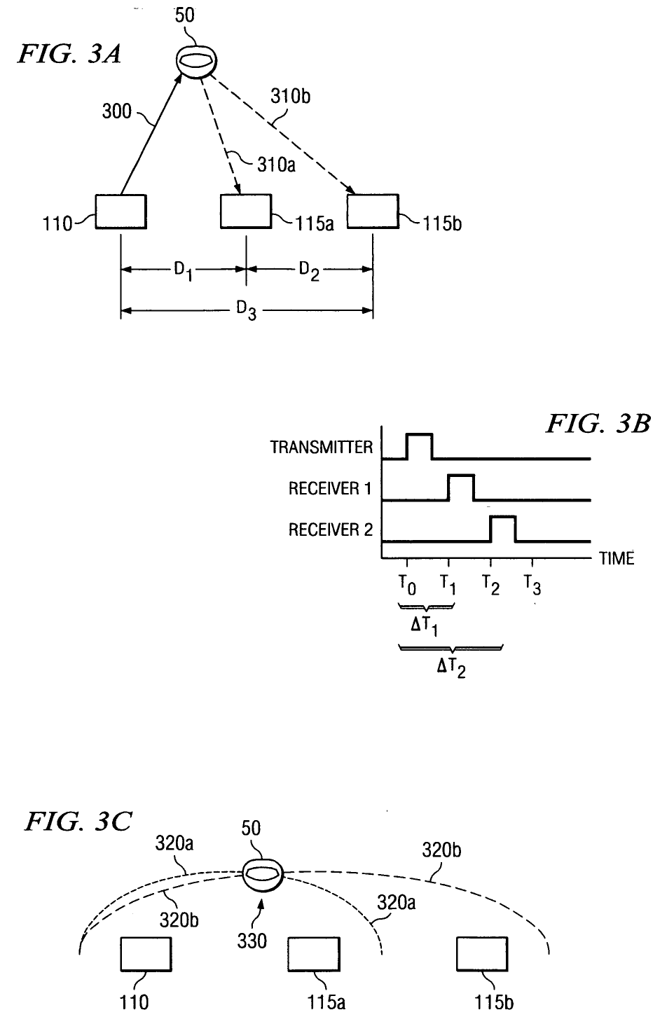

For example, referring now to FIGS. 3A-3C, one transmitter 110 and two receivers 115a and 115b are shown for simplicity. Each of the transmitter 110 and receivers 115a and 115b is at a fixed location such that the distances between them D1, D2 and D3 are known. Transmitter 110 radiates an ultrasonic pulse 300 through the virtual mouse region at an initial time T₀. The ultrasonic pulse 300 is reflected off the user-controlled object 50 as a reflected ultrasonic pulse 310. Reflected ultrasonic pulse 310 is first received at receiver 115a as reflected pulse 310a at time T₁ and reflected ultrasonic pulse 310 is next received at receiver 115b as reflected pulse 310b at time T₂.

The difference between the time at which the ultrasonic pulse is transmitted (T₀) and the time at which the reflected ultrasonic pulse 310a is received at receiver 115a (T₁) is denoted ΔT₁. The difference between the time at which the ultrasonic pulse is transmitted (T₀) and the time at which the reflected ultrasonic pulse 310b is received at receiver 115b (T₂) is denoted ΔT₂. From the time differences ΔT₁ and ΔT₂, the respective distances between each of the ultrasonic receivers 115a and 115b and the user-controlled object 50 can be represented as respective semi-ellipses 320a and 320b, each having its two foci at the locations of the transmitter 110 and respective receiver 115. For example, semi-ellipse 320a has its two foci at ultrasonic transmitter 110 and ultrasonic transceiver 115a and semi-ellipse 320b has its two foci at ultrasonic transmitter 110 and ultrasonic transceiver 115b. A current position 330 of the user-controlled object is located on ellipses 320a and 320b. Thus, the intersection of the two semi-ellipses yields the position 330 (e.g., x, y coordinates) of the user-controlled object 50 in the virtual mouse region. In embodiments in which the transmitter and receiver are co-located in a single ultrasonic transceiver, the semi-ellipse would be represented as a semi-circle.

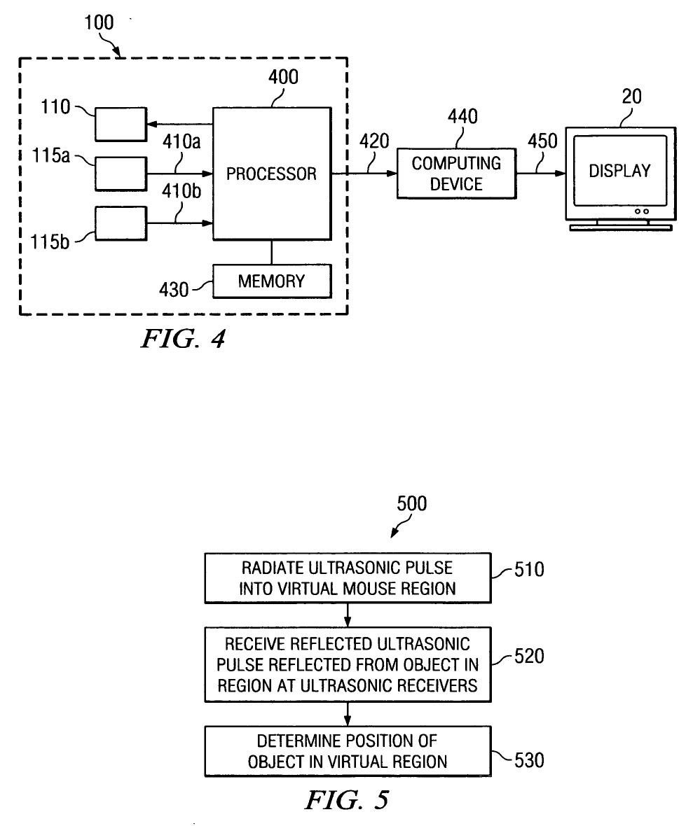

FIG. 4 is a block diagram illustrating an exemplary ultrasonic virtual mouse 100 capable of generating a position signal for controlling movement of a cursor on a display, in accordance with embodiments of the present invention. The ultrasonic virtual mouse 100 includes transmitter 110, receivers 115a and 115b, a processor 400 and a memory device 430. The processor 400 in combination with the memory device 430 controls the operation of the ultrasonic virtual mouse 100. The processor 400 is connected to control ultrasonic transmitter 110. For example, the processor 400 controls the timing of the radiation of an ultrasonic pulse into the virtual mouse region by the transmitter 110.

The processor is further connected to receive a respective reflected ultrasonic signal 410a and 410b from each of the ultrasonic receivers 115a and 115b indicative of whether a reflected ultrasonic pulse was received at the respective ultrasonic receiver 115a and 115b, and therefore, whether a user-controlled object is present in the virtual mouse region. In addition, when the reflected ultrasonic signals 410a and 410b indicate that a reflected ultrasonic pulse was received, the reflected ultrasonic signals 410a and 410b also indicate a time at which the reflected ultrasonic pulse was received at the respective ultrasonic receiver 115a and 115b.

The processor 100 determines a current position (x, y coordinates) of a user-controlled object within the virtual mouse region based on the difference between the two transit times, i.e., the difference between the time the transmitter 110 emits the pulse and the time at which the first receiver 115a receives the pulse and the difference between the time the transmitter 110 emits the pulse and the time at which the second receiver 115b receives the pulse. From the current position, the processor 400 generates a position signal 420 that is indicative of the current position. The processor 400 provides the position signal 420 to a computing device 440 (e.g., a processor within the electronic device associated with the ultrasonic virtual mouse). The computing device 440 uses the position signal 420 to generate a cursor control signal 450 that it provides to the display 20 to cause movement of the cursor on the display 20.

For example, in embodiments in which the ultrasonic virtual mouse 100 is provided with ultrasonic virtual mouse driver software loaded into the computing device 440, the position signal 420 includes the current position of the user-controlled object within the virtual mouse region, and the computing device 440 maps the current position of the user-controlled object to a corresponding cursor position on the display 20 to generate the cursor control signal 450. Thus, the cursor control signal 450 causes movement of the cursor on the display to the indicated cursor position. For example, in one embodiment, the driver software for the ultrasonic virtual mouse 100 provides a graphics pad mode that operates to map the absolute position of the user-controlled object within the virtual mouse region to a corresponding position on the display 20.

In embodiments in which the ultrasonic virtual mouse 100 emulates a conventional mouse using conventional mouse driver software loaded into the computing device 440, the processor 400 populates the position signal 420 with a relative change in position of the user-controlled object from a previous position of the user-controlled object within the virtual mouse region, and the computing device 440 uses the relative change in position when executing the conventional mouse driver software to generate the cursor control signal 450. Thus, as in some conventional mouse applications, the cursor control signal 450 produces incremental movement of the cursor on the display 20 corresponding to the relative change in position.

For example, in one embodiment, the processor 400 compares the current position of the user-controlled object in the virtual mouse region to a previous position of the user-controlled object in the virtual mouse region to determine a cursor position change (Δx, Δy) vector, and outputs the cursor position change vector in the position signal 420 to the computing device 440. The computing device 440, in turn, outputs the cursor position change vector in the cursor control signal 450 to the display 20. The cursor control signal 450 causes the cursor on the display 20 to move from a current position (x, y) on the display 20 to the new position (x+Δx, y+Δy) on the display 20 based on the cursor position change vector.

The processor 400 is further operable to initiate a timer (not shown) when the processor 400 first detects that a user-controlled object has entered the virtual mouse region (e.g., at the time when the state of one or more reflected ultrasonic signals 410a, 41b . . . 410N changes from an indication that a user-controlled object is not within the virtual mouse region to an indication that a user-controlled object is within the virtual mouse region). The timer times out after a predetermined time interval. The processor 400 continues to monitor the reflected ultrasonic signals 410a and 410b for the duration of the timer. If the state of all of the reflected ultrasonic signals 410a and 410b again changes to indicate that the user-controlled object is no longer within the virtual mouse region prior to expiration of the timer, the processor 400 detects a click event. Thus, the processor 400 detects a click event when a time difference between the time that the ultrasonic receivers receive reflected ultrasonic pulses reflected from the user-controlled object and the time that the ultrasonic receivers no longer receives reflected ultrasonic pulses is less than the predefined time interval. In response to detecting a click event, the processor 400 and/or computing device 440 is further operable to generate a click indicate signal (not shown) to provide an audible beep, tone or click to the user and/or to perform the indicated selection, execution or drag function of the click event.

The processor 400 and computing device 440 can each be a microprocessor, microcontroller, programmable logic device or any other processing device. In one embodiment, the processor 400 is implemented within the ultrasonic virtual mouse 100 and the computing device 440 is implemented within an electronic device associated with the ultrasonic virtual mouse 100. In another embodiment, the processor 400 and computing device 440 are both co-located within the ultrasonic virtual mouse 100.

The memory device 430 can be any type of memory device for use on any type of electronic device. For example, the memory device 430 can be a flash ROM, EEPROM, ROM, RAM or any other type of storage device. In one embodiment, the memory device 430 stores software executable by the processor 400 to generate the cursor control signal 420. For example, the software can include a first algorithm for determining the current position of the user-controlled object from the reflected ultrasonic signals 410a and 410b, and a second algorithm (e.g., driver software) for generating the cursor control signal 420 to control movement of the cursor on the display 20. In another embodiment, the algorithms are stored in the processor 400, and the memory device 430 stores data used by the processor 400 during execution of the algorithms. For example, the memory device 430 can store one or more of the previous position of the user-controlled object within the virtual mouse region, the predetermined time interval for click events and a mapping between virtual mouse region position and cursor position.

FIG. 5 is a flow chart illustrating an exemplary process 500 for determining position using an ultrasonic virtual mouse, in accordance with embodiments of the present invention. Initially, at block 510, an ultrasonic pulse is radiated by an ultrasonic transmitter into a virtual mouse region. At block 520, a reflected ultrasonic pulse reflected off a user-controlled object within the virtual mouse region is received by ultrasonic receivers. From the difference in transit times between transmission of the ultrasonic pulse and reception of the reflected ultrasonic pulses, at block 530, the position of the user-controlled object within the virtual mouse region is determined. The position can be used, for example, to control a cursor on a display.

The innovative concepts described in the present application can be modified and varied over a wide rage of applications. Accordingly, the scope of patents subject matter should not be limited to any of the specific exemplary teachings discussed, but is instead defined by the following claims.

We claim:

1. An ultrasonic device for determining a position of a user-controlled object within a virtual mouse region, said ultrasonic device comprising:
an ultrasonic transmitter for producing an ultrasonic pulse and radiating said ultrasonic pulse into said virtual mouse region;
spatially separated ultrasonic receivers for receiving a reflected ultrasonic pulse reflected from said user-controlled object within said virtual mouse region and producing respective reflected ultrasonic signals; and
a processor operable to determine said position of said user-controlled object within said virtual mouse region based on said reflected ultrasonic signals and to generate a position signal indicative of said position.

2. The ultrasonic device of claim 1, wherein said processor is operable to determine said position based on a difference between times at which said respective reflected ultrasonic pulse is received by said spatially separated ultrasonic receivers.

3. The ultrasonic device of claim 1, wherein said processor is operable to compare said position to a previous position to determine a relative change in position of said user-controlled object, and wherein said processor is further operable to generate said position signal in response to said relative change in position.

4. The ultrasonic device of claim 3, wherein said position signal is used to produce incremental movement of a cursor on a display from an original position on said display to a new position on said display.

5. The ultrasonic device of claim 1, wherein said position signal is used to map said position to a position of a cursor on a display.

6. The ultrasonic device of claim 1, wherein said ultrasonic transmitter and one of said ultrasonic receivers form an ultrasonic transceiver.

7. The ultrasonic device of claim 1, additionally comprising:
an additional ultrasonic transmitter for producing and radiating an additional ultrasonic pulse into said virtual mouse region.

8. The ultrasonic device of claim 7, wherein each of said ultrasonic transmitters produce and radiate said respective ultrasonic pulses sequentially.

9. The ultrasonic device of claim 1, wherein said ultrasonic device is mounted on a keyboard.

10. The ultrasonic device of claim 1, wherein said ultrasonic device is included within a keyboard.

11. The ultrasonic device of claim 1, wherein said two receivers are arrayed in two dimensions.

12. The ultrasonic device of claim 1, wherein said processor is further operable to detect a click event based on said reflected ultrasonic pulse.

13. The ultrasonic device of claim 12, wherein said processor is operable to detect said click event when a difference between a time at which said reflected ultrasonic pulse is first received and a time at which said reflected ultrasonic pulse is no longer received is less than a predetermined time interval.

14. The ultrasonic device of claim 1, wherein said processor is further operable to configure said virtual mouse region.

15. The ultrasonic device of claim 1, wherein said ultrasonic pulse is at a frequency between 22 kHz and 100 kHz.

16. The ultrasonic device of claim 1, wherein said user-controlled object is a finger or stylus.

17. A method for determining a position of a user-controlled object within a virtual mouse region, comprising:
radiating an ultrasonic pulse into said virtual mouse region;
at diverse locations, receiving a reflected ultrasonic pulse reflected from said user-controlled object within said virtual mouse region; and
determining said position of said user-controlled object within said virtual mouse region based on said receipt of said reflected ultrasonic pulse at said diverse locations.

18. The method of claim 17, wherein said determining further includes:
determining said position based on a difference between times at which said reflected ultrasonic pulse is received at said diverse locations.

19. The method of claim 17, wherein said determining said position further comprises:
comparing said position to a previous position to determine a relative change in position of said user-controlled object.

20. The method of claim 19, further comprising:
providing said position to produce incremental movement of a cursor on a display from an original position on said display to a new position on said display.

21. The method of claim 17, further comprising:
providing said position to map said position to a position of a cursor on a display.

22. The method of claim 17, wherein said transmitting further includes:
sequentially radiating an additional ultrasonic pulse into said virtual mouse region.

23. The method of claim 17, further comprising:
detecting a click event based on said reflected ultrasonic pulse.

24. The method of claim 23, wherein said detecting further includes:
detecting said click event when a difference between a time at which said reflected ultrasonic pulse is first received and a time at which said reflected ultrasonic pulse is no longer received is less than a predetermined time interval.

25. The method of claim 17, further comprising:
configuring said virtual mouse region.
